(19) United States
(12) Patent Application Publication
(10) Pub. No.: US 2026/0359824 A1
(43) Pub. Date: Nov. 12, 2026

(54) System and method of implementing indirect KYC within a distributed ledger network

(71) Applicant: Tingkai Liu, Lisle, IL (US)

(72) Inventor: Tingkai Liu, Lisle, IL (US)

(21) Appl. No.: 19/204,608

(22) Filed: May 12, 2025

(51) Int. Cl. G06Q 20/40; G06Q 20/06; G06Q 20/38

(52) U.S. Cl. CPC G06Q 20/4016; G06Q 20/0655; G06Q 20/3829; G06Q 20/389; G06Q 20/3825; G06Q 20/3827

(57) ABSTRACT

The present invention provides a computer-implemented system and method of implementing indirect Know Your Customer (KYC) within a distributed ledger (DL) network. Users associate their cryptocurrency accounts with verified identities by registering these accounts with recognized financial institutions (banks). Banks perform identity verification and offer publicly accessible verification services. Transactions on the DL network include identification information of both sender's and recipient's banks. DL network validators authenticate digital signatures and utilize these bank services to confirm crypto account registration statuses. Transactions are approved only upon receiving positive validation from the designated banks. Participating banks exclusively facilitate KYC processes without taking custody of cryptocurrency, ensuring regulatory compliance while preserving decentralization and user privacy.

### FIELD OF THE INVENTION

The invention pertains to the field of payment schemes. More particularly, the invention pertains to a computer-implemented system and method of implementing indirect Know Your Customer (KYC) verification for a distributed ledger (DL) network.

### BACKGROUND OF THE INVENTION

Current public blockchains and distributed ledger (DL) systems circumvent traditional financial institutions, and consequently, the KYC processes those institutions enforce. This creates an environment where illegal transactions can flourish.

KYC procedures are critical for financial institutions to verify customer identities and to safeguard against criminal activities such as drug trafficking, terrorism, and money laundering. Fortunately, the majority of adults worldwide already maintain bank accounts, indicating that they have previously completed KYC verification with their respective banks. This represents a significant opportunity for the cryptocurrency industry to enhance compliance by leveraging existing KYC frameworks while preserving the decentralized nature of DL technologies.

There is both a need and an opportunity to implement KYC compliance and thus enhance security within DL networks by utilizing distributed KYC data maintained by banks globally, without undermining the decentralization that defines these systems.

### SUMMARY OF THE INVENTION

The present invention discloses a computer-implemented system and method for implementing indirect KYC for a distributed ledger (DL) network. Users register their crypto accounts with banks, which verify their identities and provide publicly accessible verification services. When preparing a transaction, the sender includes information about the sender's and recipient's banks, such as their domain names. Upon submission of the transaction to the DL network, validators authenticate the digital signatures and consult the designated bank services to verify the registration status of the crypto accounts. Validators confirm the transaction only if the bank services return a response indicating approval. Banks participate solely for KYC purposes and do not take custody of any cryptocurrency, thereby maintaining a minimal but essential role in supporting regulatory compliance. This model achieves regulatory oversight without compromising decentralization or user privacy.

### BRIEF DESCRIPTION OF THE DRAWING

FIG. 1 illustrates a high-level overview of a transaction from Alice to Bob, incorporating BANKs for KYC validation in a distributed ledger network.

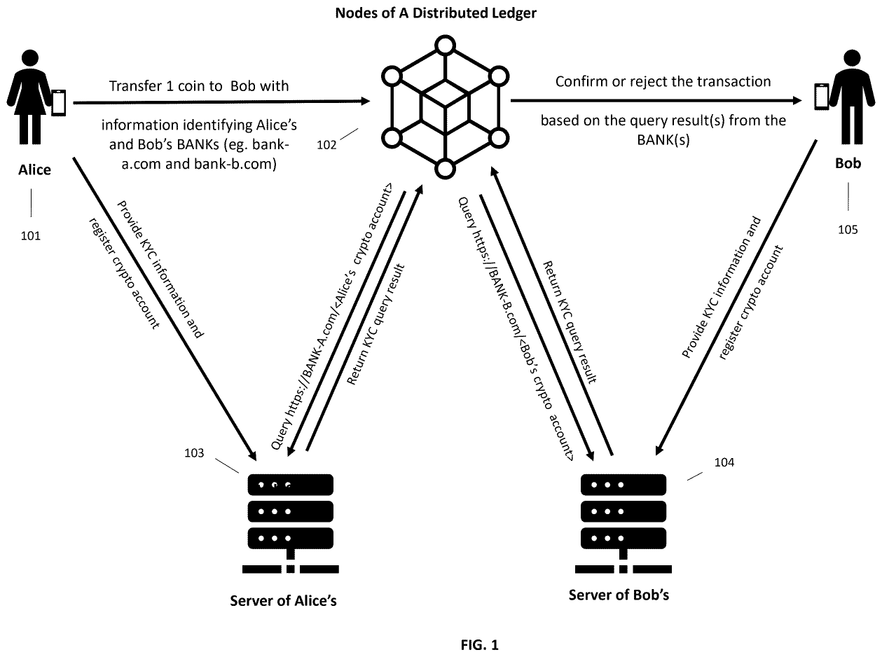

FIG. 2 is a detailed process flowchart, outlining steps from key management and transaction preparation through BANK verification and DL validation.

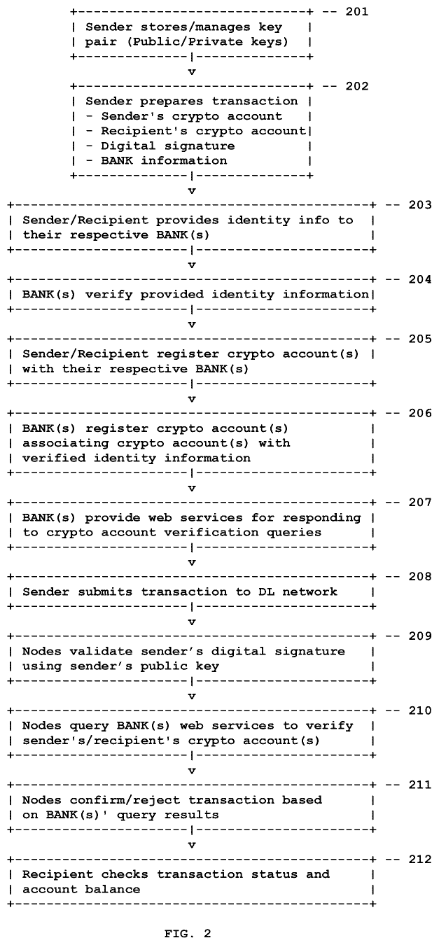

### DETAILED DESCRIPTION OF THE INVENTION

### Glossary of Terms

Plurality: More than one.

Distributed ledger (DL) or distributed ledger network (DL network): A network of independent nodes maintaining synchronized electronic records.

Distributed ledger technology (DLT): Protocols and infrastructure supporting DL networks.

45 Blockchain: A type of DL organized into cryptographically chained blocks.

Miner: A DL node operator responsible for validating transactions.

Cryptocurrency (crypto): A cryptographically secure digital currency.

Cryptocurrency address: A public identifier for receiving crypto assets.

Cryptocurrency account: A cryptocurrency address or an identifier derived from a cryptocurrency address or any data that may be used to identify a cryptocurrency address.

KYC: Know Your Customer or Know Your Client or Know Your User, a legal compliance process verifying customer or client or user identity.

KYC provider: An institution that offers KYC services, with the majority of KYC providers being banks. For simplicity and readability, the present disclosure uses the capitalized term “BANK” to refer to a KYC provider.

BANK: A KYC provider.

KYC is a legally mandated process for financial institutions such as banks and exchanges. However, the emergence of distributed ledger technologies complicates enforcement, as these systems lack a centralized authority for regulators to target. Entities operating nodes within distributed ledgers (also known as miners) are often difficult to be classified strictly as financial institutions and may operate across multiple jurisdictions, further complicating regulatory oversight. Fortunately, a majority of adults worldwide already possess BANK accounts, indicating they've previously undergone KYC procedures with their respective BANKs. This existing KYC data is inherently decentralized, as it is maintained independently by various BANKs. Leveraging this distributed KYC data presents a great opportunity for the cryptocurrency industry to establish a robust and decentralized KYC system.

While it is not practical to require miners of a distributed ledger (DL) to directly perform KYC verification for participants of a cryptocurrency transaction, it is feasible to mandate miners to adopt a protocol that verifies whether a cryptocurrency account involved in a transaction is registered with a BANK. Under this approach, miners would only confirm a transaction after receiving a approval response from the BANKs referenced in the transaction. The validation may be automated through web request and response on BANK's servers. Since these BANKS already maintain KYC information on their customers who register crypto account, law enforcement agencies could readily oversee transactions through cooperation with the BANKs. This method of indirect KYC ensures regulatory compliance for cryptocurrency transactions while preserving the inherently decentralized nature of distributed ledger technologies.

### System Description

The present disclosure embodies a system for said implementing indirect KYC verification within a distributed ledger (DL) network, comprising:
a sender's device (101) configured to:
   store and manage at least one pair of public and private keys, wherein the public key may be used to create a cryptocurrency address which is or is associated with a cryptocurrency account, and the private key may be used for digital signatures;
   generate a transaction including the sender's cryptocurrency account, a recipient's cryptocurrency address which is or is associated with another cryptocurrency account, a digital signature generated using the sender's private key, and information identifying a BANK the sender's cryptocurrency account is registered with (the sender's BANK) or a BANK the recipient's cryptocurrency account is registered with (the recipient's BANK) or both; and
   submit the transaction to the DL network;
a server of the sender's BANK (103), or a server of the recipient's BANK (104), or servers of both BANKs, configured to:
   receive identity information from users for KYC verification;
   register cryptocurrency accounts for users;
   associate the registered cryptocurrency account(s) with the user identity information respectively; and
   respond to queries regarding registered cryptocurrency account(s);
a plurality of nodes within the DL network (102) configured to:
   authenticate the sender's cryptocurrency account by validating the digital signature using the sender's public key;
   query the cryptocurrency account of the sender with the sender's BANK server or query the cryptocurrency account of the recipient with the recipient's BANK server, or perform both queries; and
   confirm or reject the transaction based on the query result(s); and optionally
a recipient's device (105) configured to check transaction status and account balance.

### Method Description

The present disclosure also embodies A method for implementing indirect KYC verification within a distributed ledger (DL) network, comprising the steps of:
storing and managing, by a sender, at least one pair of public and private keys, wherein the public key may be used to create a cryptocurrency address which is or is associated with a cryptocurrency account, and the private key may be used for digital signatures (201);
preparing, by the sender, a transaction including the sender's cryptocurrency account, a recipient's cryptocurrency address which is or is associated with another cryptocurrency account, a digital signature generated using the sender's private key, and information identifying a BANK the sender's cryptocurrency account is registered with (the sender's BANK) or a BANK the recipient's cryptocurrency account is registered with (the recipient's BANK) or both (202);
providing identity information by the sender or the recipient, or both, to their respective BANK(s) (203);
verifying the provided identity information by the respective BANK(s) (204);
registering the sender's cryptocurrency account with the sender's BANK by the sender or the recipient's cryptocurrency account with the recipient's BANK by the recipient, or both (205);
associating the sender's cryptocurrency account with the sender's verified identity information by the sender's BANK, or associating the recipient's cryptocurrency account with the recipient's verified identity information by the recipient's BANK, or both (206);
providing, by the BANK(s), web-based services to respond to queries regarding registered cryptocurrency account(s) (207);
submitting the prepared transaction by the sender to the DL network (208);
authenticating the sender's cryptocurrency account using the digital signature and public key by nodes of the DL network (209);
querying the cryptocurrency accounts of the sender or recipient or both, with their respective BANK(s) by the DL nodes (210);
confirming or rejecting the transaction based on the query result(s) by the DL nodes (211); and optionally
checking transaction status and account balance by the recipient (212).

### AN EXAMPLE

For example, suppose Alice wants to transfer 1 ETH to Bob. Under the current Ethereum blockchain process, Alice enters Bob's cryptocurrency address along with the amount she intends to send, digitally signs the transaction using her private key, and submits it to the blockchain. Miners validate only two things: whether Alice's account holds sufficient funds, and the authenticity of the digital signature of the transaction using the sender's public key. This approach entirely bypasses KYC procedures, creating significant challenges for law enforcement to oversee transactions. A typical Ethereum transaction currently looks like this:

| Field | Example Data | | Description |
|---|---|---|---|
| From | 0xa11ceadd2 . . . ef123 | | Sender wallet address |
| To | 0xb0badd255 . . . ba987 | | Recipient wallet address |
| Amount | 1 | ETH | Ether being sent |
| Gas Limit | 21,000 | | Max gas units allowed |
| Gas Price | 50 | Gwei | Fee per gas unit |
| Nonce | 7 | | Sender's transaction count |
| Input | | | No extra data |

| | | |
|---|---|---|
| Signature | 0x25 0x1b . . . 9e 0x5 . . . | Digital signature components |
| | 9f20 | |

In a typical implementation of the present disclosure, both Alice and Bob are required to register their cryptocurrency addresses with their respective banks. Assume Alice is a customer of Bank-A in the U.S., and Bob is a customer of Bank-B in Brazil, with both banks providing Know Your Customer (KYC) services. Since Alice is already a verified customer, Bank-A simply associates her cryptocurrency address with her verified identity in its records. Bank-A also offers a web service that allows queries to confirm if a crypto address is registered and active for transactions. Similarly, Bob registers his crypto address with Bank-B, which also provides a web query service.

When Alice prepares a transaction, she follows the standard Ethereum process and adds an extra step by including her and Bob's bank domain names in the Input data field. This enables miners to indirectly verify their identities. The transaction structure appears as follows:

| Field | Example Data | | Description |
|---|---|---|---|
| From | 0xa11ceadd2 . . . ef123 | | Sender wallet address |
| To | 0xb0badd255 . . . ba987 | | Recipient wallet address |
| Amount | 1 | ETH | Ether being sent |
| Gas Limit | 21,000 | | Max gas units allowed |
| Gas Price | 50 | Gwei | Fee per gas unit |

| Nonce | 7 | Sender's transaction count |
|---|---|---|
| Input | bank-a.com; bank-b.com | Sender's & Recipient's banks |
| Signature | 0x25 0x1b . . . 9e 0x5 . . . | Digital signature components |
| | 9f20 | |

This is a non-conventional transaction data structure which includes:
(1) the BANK-registered cryptocurrency address of the sender;
(2) a recipient's cryptocurrency address;
(3) the BANK identifiers; and
(4) a digital signature generated using the sender's private key.

The bank identifiers are included in the Input data field in this example, but they can be included in other data fields such as signature script or a new data field as well.

Upon receiving the transaction, miners validate it using the standard Ethereum procedures which authenticate the digital signature of the transaction using the sender's public key, and additionally verify the sender's and recipient's cryptocurrency addresses by querying the respective banks listed in the Input data. Sample queries may look like:
For Alice query: https://bank-a.com/0xa11ceadd255123456789abcd0ef0000abcdef123
For Bob query: https://bank-b.com/0xb0badd255987654321fedcba0000000fedcba987
   where https means the servers' responses are digitally signed by the BANK servers. Each of the responses includes a registration flag which is used to indicate whether the addresses are valid, active, for receiving only, sanctioned or any other status. To make this work efficiently, the server's response objects are designed to be machine-readable and to conform to a predetermined schema enabling deterministic validation by computing device(s), so that miners can retrieve the machine-readable verification object from the BANK servers easily. If both banks confirm the addresses are valid and active through the registration flag, miners proceed to confirm the transaction, provided it meets all other Ethereum validation criteria. If either bank does not confirm the address, miners reject the transaction.

Miners do not directly verify the identities of Alice or Bob; they simply query the banks regarding the crypto addresses involved. Banks provide public web services indicating the validity status of crypto addresses without revealing personal information. Thus, once the transaction is confirmed and recorded on the blockchain, anyone viewing the transaction can identify the banks associated with the sender's and recipient's addresses but cannot ascertain the individuals' identities without bank cooperation.

Law enforcement agencies can oversee cryptocurrency transactions by collaborating with these banks, ensuring robust KYC compliance while preserving blockchain decentralization.

There are alternative approaches for implementing this disclosure. For example, one-sided KYC may be employed, where only either the sender or the recipient registers their crypto account with a BANK. Additionally, the crypto account may be derived from the crypto address, such as using its hash, enhancing tracking difficulty and preserving user privacy. Another possibility is using transaction identifiers and output indices as crypto accounts, which can also be registered with a bank. To implement such variations, miners must synchronize their validation protocols regarding how crypto accounts are derived.

Permissionless distributed ledgers or blockchains rely solely on cryptography to secure cryptocurrency transactions. If a user's private key is compromised, they risk losing all associated cryptocurrency. While law enforcement might identify attackers with cooperation from the attacker's bank in the disclosed system, the recovery cost can be substantial, especially for cross-border transactions. Preventing such incidents proactively is preferable. Although cryptography is statistically secure, it depends on assumptions like absolute randomness in key generation, which is practically challenging, and users' ability to safeguard their private keys, often undermined by social engineering attacks. Banks employ sophisticated mechanisms to mitigate these risks, including two-factor authentication, transaction pauses upon suspicious activities, and procedural checks for significant transactions. Furthermore, current cryptographic methods face vulnerabilities from emerging quantum computing technologies. Banks are expected to enhance their security systems to withstand quantum attacks. The present disclosure embodies additional configurations and steps to leverage these advanced bank security measures to significantly strengthen the security of distributed ledgers.

### Enhancement of Network Security

The system for implementing indirect KYC within a distributed ledger (DL) may include the following additional configurations:

The sender's device (101) may be configured to generate a cryptocurrency address that incorporates the sender's BANK information which can be a BANK identifier encoded as a fixed-length institution code from a predefined namespace or encoded as a string comprising the BANK's domain name, and the sender's public key. This crypto address is referred to as a BANK-bound cryptocurrency address, which can either serve directly as, or be used to derive, the sender's crypto account. For instance, Alice's crypto address might be derived as the last 40 characters of a hash of both her bank's domain name and her public key. Here is the pseudo-code to generate Alice's BANK-bound cryptocurrency address:

```
HASH(
  Bank-A.com| #Alice's Bank domain name
  0x04a34b7dcdf4b8e6f378b29c20a0f9f64f5dc8b9dc2ed2a96c457640d2fa5b09e2e3f497e3efe
  a8a682d9797cc20a4575be682f1eabb0b7de2a905030cc56f3d55 #Alice's public key
)
```

The hash value is
21cd5f2b6fcacb2ba01adddd57298ccab63ea149e244978a8fdc53ce77ff3084
Extract last 40 characters of the hash value and prepend 0x to it to get the final address like: 0x57298ccab63ea149e244978a8fdc53ce77ff3084

This crypto address would function as her crypto account directly.

Servers belonging to the sender's BANK (103) may be configured to accept only the initial registration for each crypto account, rejecting subsequent attempts to register the same account. In this scenario, Alice needs to promptly register her crypto account with Bank-A to prevent potential attackers from doing so first. She can complete this registration before funding the account. After registering, Alice may set the registration flag to “receiving” in her Bank's service, allowing the account solely to receive cryptocurrencies, not send them. She will change the registration flag to “sending” only when she intends to initiate a transaction.

Nodes within the DL (102) can be configured to validate crypto addresses by applying the same address-generation rule as the sender's device, subsequently reconstructing the crypto account. The address-generation rule incorporates the sender's BANK information and the sender's public key into the crypto address. In case public key is not disclosed in a transaction, the nodes can recover it from the signature of the transaction. Nodes will only query the sender's crypto account with the BANK embedded in the crypto address and ignore other BANK(s) mentioned in the transaction. In Alice's case, miners will exclusively verify her crypto account with Bank-A, ignoring queries to any other banks provided in the transaction. This approach adds an additional security layer managed by Alice's bank. If an attacker compromises Alice's private key, this alone does not allow unauthorized cryptocurrency transfers. Miners will not validate transactions initiated from her account because Bank-A incorporated in the crypto address indicates the account is restricted to receiving only as registration flag. The attacker might try to register the crypto account with Bank-A, but the bank will reject the registration because the account has already been registered by Alice. Consequently, the attacker would also need to breach Alice's bank account to transfer the crypto, which is a significantly more challenging task. In this approach, the bank effectively safeguards Alice's cryptocurrency without actually holding custody of it.

The present disclosure implements KYC compliance and enhances security within DL networks by utilizing distributed KYC data maintained by banks globally, without undermining the decentralization that defines these systems.

1. A system for performing protocol-level indirect Know-Your-Customer (KYC) verification in a distributed ledger (DL) network, the system comprising:
a sender computing device comprising at least one processor, memory, and a network interface, the sender computing device configured to:
store a cryptographic keypair including a public key and a private key;
generate a BANK-bound cryptocurrency address using a non-conventional address-derivation algorithm that cryptographically combines:
(1) a BANK identifier encoded as a fixed-length institution code from a predefined namespace or encoded as a string comprising the BANK's domain name; and
(2) the sender's public key;
prepare a transaction with a non-conventional transaction data structure, the data structure including:
(1) the BANK-bound cryptocurrency address;
(2) a recipient's cryptocurrency address;
(3) the BANK identifier; and
(4) a digital signature generated using the private key; and
transmit the transaction to the DL network;
a BANK server corresponding to the BANK identifier, the BANK server comprising at least one processor and memory storing executable instructions that configure the BANK server to:
receive identity information from users for KYC verification;
register cryptocurrency addresses associated with verified identities;
store a mapping between each registered address and a corresponding verified-identity record;
generate a machine-readable verification object, the verification object:
(1) being digitally signed by the BANK server;
(2) including at least a registration flag; and
(3) conforming to a predetermined schema enabling deterministic validation by computing device(s);
respond with the verification object to queries regarding the registered cryptocurrency address;
a plurality of consensus nodes of the DL network, each consensus node comprising at least one processor and memory storing executable instructions that configure the consensus node to:
authenticate the digital signature of the transaction using the sender's public key;
reconstruct the BANK-bound cryptocurrency address by applying the non-conventional address-derivation algorithm used by the sender device;
verify that the reconstructed address matches the address included in the transaction;
query, as a consensus-rule requirement, only the BANK server identified in the BANK-bound address, irrespective of any other BANK information included in the transaction;
retrieve the machine-readable verification object from the BANK server; and
approve or reject the transaction as part of block-validation consensus based at least on:
(1) validity of the BANK server's digital signature; and
(2) the registration flag contained within the verification object;
wherein the BANK-bound address structure, deterministic BANK-routing rule, and machine-readable verification object collectively improve the functioning of the distributed-ledger network by enabling unambiguous identity-resolution routing, reducing consensus-layer computation during KYC validation and achieving KYC compliance leveraging existing banking systems.

2. The system of claim 1, further comprising a recipient computing device configured to determine transaction status and compute a balance associated with the recipient's cryptocurrency address using validated ledger data.

3. The system of claim 1, wherein the non-conventional address-derivation algorithm used by the sender computing device comprises hashing the BANK identifier concatenated with the sender's public key to form a hash value of the combined string, and extracting a predetermined subset of bits from the hash value of the combined string.

4. The system of claim 1, wherein reconstructing the cryptocurrency address by the consensus nodes comprises recovering the sender's public key from the digital signature of the transaction data structure and hashing the BANK identifier concatenated with the recovered public key to form a reconstructed hash value, and extracting the predetermined subset of bits from the reconstructed hash value.

5. A computer-implemented method for performing protocol-level indirect KYC verification within a distributed-ledger (DL) network, the method comprising:
storing, by a sender computing device, a cryptographic keypair including a public key and a private key;
generating, by the sender computing device, a BANK-bound cryptocurrency address using a non-conventional address-derivation algorithm that cryptographically combines:
(1) a BANK identifier encoded as a fixed-length institution code from a predefined namespace or encoded as a string comprising the BANK's domain name; and
(2) the sender's public key;
preparing, by the sender computing device, a transaction with a non-conventional transaction data structure, the data structure including:
(1) the BANK-bound cryptocurrency address;
(2) a recipient's cryptocurrency address;
(3) the BANK identifier; and
(4) a digital signature generated using the private key;
providing identity information by the sender to the BANK;
verifying the provided identity information by the BANK;
registering the BANK-bound cryptocurrency address with the BANK by the sender;
storing, by the BANK server, a mapping between each registered address and a corresponding verified-identity record;
generating, by the BANK server, a machine-readable verification object, the verification object:
(1) being digitally signed by the corresponding BANK server;
(2) including at least a registration flag; and
(3) conforming to a predetermined schema enabling deterministic validation by consensus nodes of the DL network;
responding with the verification object, by the BANK server, to queries regarding any cryptocurrency address(es);
submitting the prepared transaction by the sender computing device to the consensus nodes of the DL network;
authenticating, by the consensus nodes of the DL network, the digital signature of the transaction using the sender's public key;
reconstructing, by the consensus nodes, the BANK-bound cryptocurrency address by applying the non-conventional address-derivation algorithm used by the sender computing device;
verifying, by the consensus nodes, that the reconstructed address matches the BANK-bound cryptocurrency address included in the transaction;
querying the BANK-bound cryptocurrency address with the BANK server by the consensus nodes;
retrieving, by the consensus nodes of the DL network, the machine-readable verification object from the BANK server; and
approving or rejecting, by the consensus nodes, the transaction as part of block-validation consensus based at least on:
(1) validity of the BANK server's digital signature; and
(2) the registration flag contained within the verification object;
wherein the BANK-bound address structure, deterministic BANK-routing rule, and machine-readable verification object collectively improve the functioning of the distributed-ledger network by enabling unambiguous identity-resolution routing, reducing consensus-layer computation during KYC validation and achieving KYC compliance leveraging existing banking systems.

6. The method of claim 5, further comprising:
checking transaction status and account balance by a recipient computing device.

7. The method of claim 5, wherein generating the BANK-bound cryptocurrency address comprises hashing the BANK identifier concatenated with the sender's public key to form a hash value of the combined string, and extracting a predetermined subset of bits from the hash value of the combined string.

9. The method of claim 5, wherein reconstructing the cryptocurrency address by the consensus nodes comprises recovering the sender's public key from the digital signature of the transaction data structure and hashing the BANK identifier concatenated with the recovered public key to form a reconstructed hash value, and extracting the predetermined subset of bits from the reconstructed hash value.
